(19) United States
(12) Patent Application Publication
(10) Pub. No.: US 2010/0165007 A1
(43) Pub. Date: Jul. 1, 2010

(54) DISPLAY DEVICE AND SOURCE LINE DRIVING METHOD THEREOF

(76) Inventor: Jeong-Min Kim, Seongbuk-gu (KR)

Correspondence Address: SHERR & VAUGHN, PLLC, 620 HERNDON PARKWAY, SUITE 320, HERNDON, VA, 20170, US

(21) Appl. No.: 12/649,189

(22) Filed: Dec. 29, 2009

(30) Foreign Application Priority Data
Dec. 30, 2008 (KR) 10-2008-0136639

(51) Int. Cl. G09G 5/10

(52) U.S. Cl. 345/690

(57) ABSTRACT

A display device for generating gamma voltages for driving source lines and a source line driving method thereof are disclosed. The display device includes a plurality of gamma generation units configured to generate gamma voltages corresponding to respective colors, a selection unit configured to select gamma voltages corresponding to any one color from among the gamma voltages generated by the plurality of gamma generation units and to output the gamma voltages to a common line, a decoding unit configured to decode the gamma voltages output to the common line, and an output unit configured to buffer the signals decoded by the decoding unit and to output source line driving signals. Thus, it is possible to reduce the number of lines for transferring the gamma voltages.

The present application claims priority under 35 U.S.C. 119 to Korean Patent Application No. 10-2008-0136639 (filed on Dec. 30, 2008), which is hereby incorporated by reference in its entirety.

### BACKGROUND

A display device implements a gray level voltage of each of three colors, that is, R (Red), G (Green) and B (Blue), through a gamma resistor string. This voltage is provided as an input of a source driver. Referring to FIG. 1, bus lines BL are connected according to gray level voltages generated through a gamma resistor string 16 and the bus lines BL are connected to source drivers 14 and 15.

However, if 0 to 256 gray level voltages are generated through the gamma resistor string 16 in the structure of FIG. 1, 256 bus lines BL are necessary for each of red, green and blue, for independent gamma implementation. That is, a total of 768 bus lines BL are included, and the height of the bus lines BL becomes the height of source channels 11 and 12. In a general display device, when a large number of bus lines is included for independent gamma implementation, the area of the display device is increased.

### SUMMARY

Embodiments relate to a display device, and more particularly, to a display device for generating gamma voltages for driving source lines and a source line driving method thereof. Embodiments relate to a display device capable of reducing the chip area occupied by the device by reducing the number of RGB gamma bus lines, and a source line driving method thereof.

Embodiments relate to a display device which may include a plurality of gamma generation units configured to generate gamma voltages corresponding to respective colors, a selection unit configured to select gamma voltages corresponding to any one color from among the gamma voltages generated by the plurality of gamma generation units and to output the gamma voltages to a common line, a decoding unit configured to decode the gamma voltages output to the common line, and an output unit configured to buffer the signals decoded by the decoding unit and to output source line driving signals.

The plurality of gamma generation units may include a first gamma generation unit configured to generate first gamma voltages corresponding to red, a second gamma generation unit configured to generate second gamma voltages corresponding to green, and a third gamma generation unit configured to generate third gamma voltages corresponding to blue.

Each of the first to third gamma generation units may include a resistor string configured to divide a source voltage so as to generate voltages having various levels, and amplifiers configured to be turned on in response to enable signals and to amplify the voltages generated by the resistor string. The amplifiers respectively included in the first to third gamma generation units may be turned on at different time points by the enable signals.

The selection unit may include a first switch configured to selectively transfer the first gamma voltages generated by the first gamma generation unit to the common line in response to a first selection signal, a second switch configured to selectively transfer the second gamma voltages generated by the second gamma generation unit to the common line in response to a second selection signal, and a third switch configured to selectively transfer the third gamma voltages generated by the third gamma generation unit to the common line in response to a third selection signal.

Embodiments relate to a source line driving method of a display device includes generating gamma voltages corresponding to respective colors by a plurality of gamma generation units, selecting gamma voltages corresponding to a specific color from among the gamma voltages by the plurality of gamma generation units and outputting the gamma voltages to a common line, decoding the gamma voltages transferred to the common line, and buffering the decoded signals and outputting signals for controlling the driving of source lines.

The gamma voltages corresponding to the respective colors may include first gamma voltages corresponding to red, second gamma voltages corresponding to green and third gamma voltages corresponding to blue. The first to third gamma voltages may be amplified and generated at different time points by enable signals.

The first gamma voltages may be selectively transferred to the common line by a first selection signal, the second gamma voltages may be selectively transferred to the common line by a second selection signal, and the third gamma voltages may be selectively transferred to the common line by a third selection signal.

The gamma voltages corresponding to the respective colors may be generated by selectively amplifying the voltages generated by dividing a source voltage by enable signals.

### DRAWINGS

FIG. 1 is a block diagram showing a related display device.

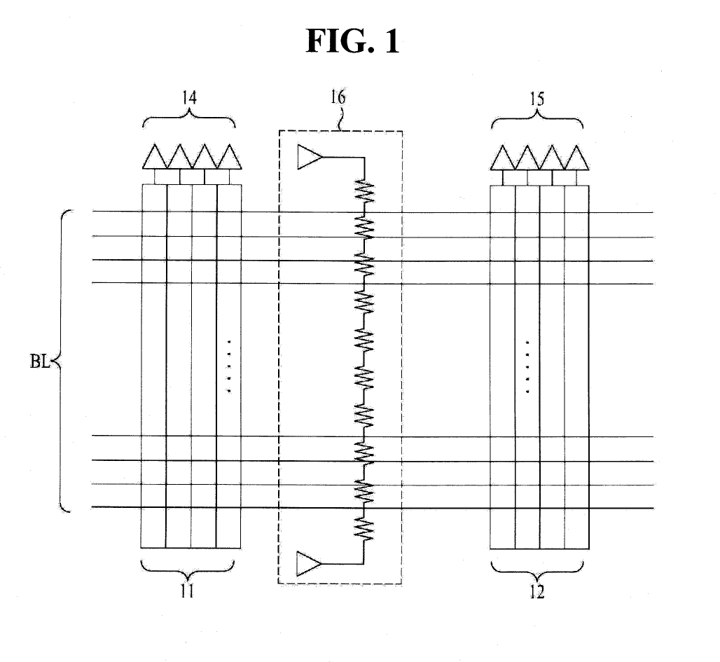

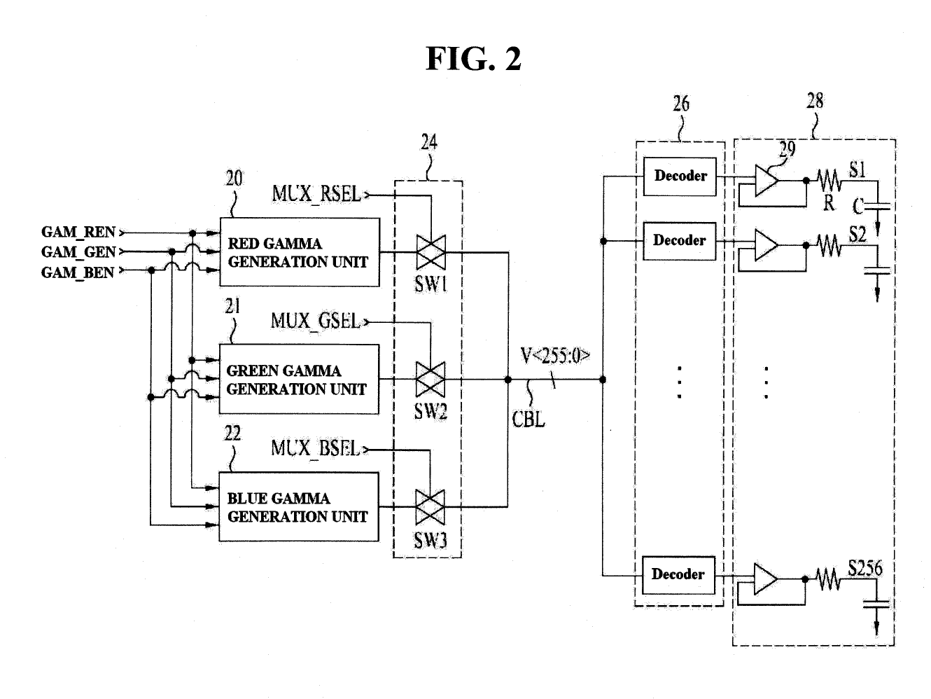

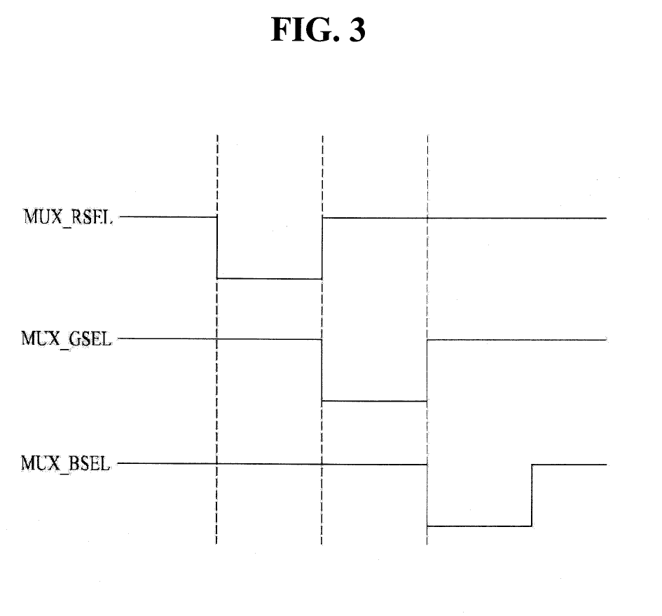

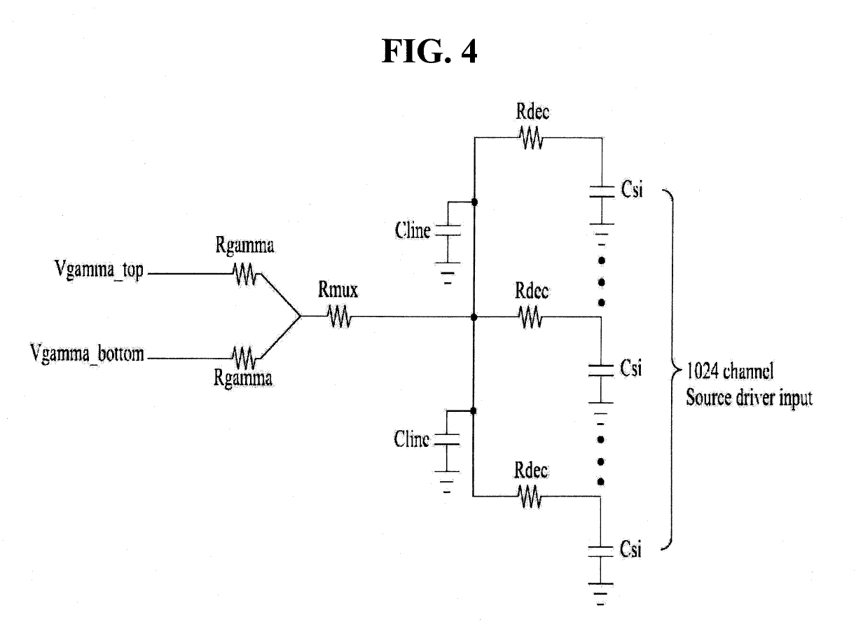

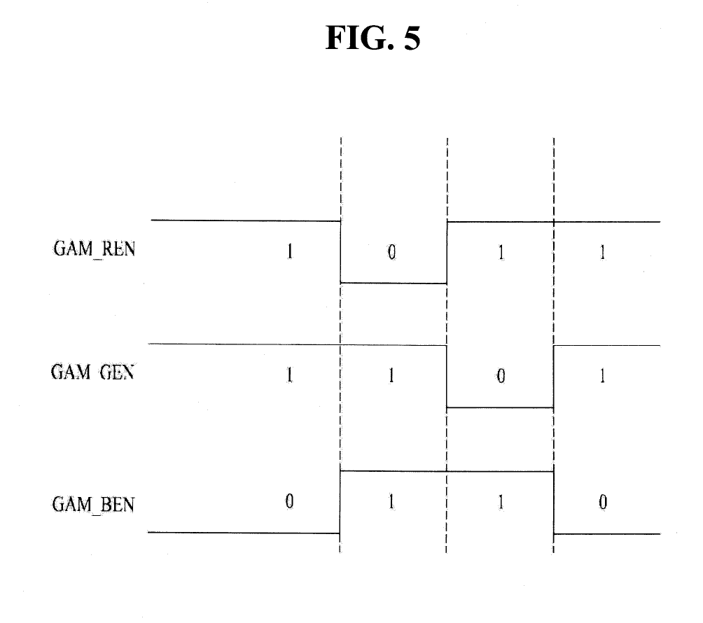

Example FIG. 2 is a block diagram showing a display device according to embodiments.

Example FIG. 3 is a waveform diagram showing enable time points of selection signals of the display device according to embodiments.

Example FIG. 4 is a circuit diagram showing RC modeling of the display device according to embodiments.

Example FIG. 5 is a waveform diagram showing the waveforms of enable signals GAM_REN, GAM_GEN, and GAM_BEN of the display device according to embodiments.

### DESCRIPTION

Hereinafter, a display device and a source line driving method according to embodiments will be described in detail with reference to the accompanying drawings. Embodiments relate to a display device capable of reducing the number of bus lines, by selecting gamma voltages corresponding to any one color from among gamma voltages corresponding to RGB and transferring the gamma voltages to the bus lines.

Example FIG. 2 is a block diagram showing a display device according to embodiments. In particular, referring to example FIG. 2, the display device according to embodiments may include a plurality of gamma generation units 20 to 22, a selection unit 24, a plurality of decoders 26, and an output unit 28.

The plurality of gamma generation units 20 to 22 may include a red gamma generation unit 20 for red, a green gamma generation unit 21 for green and a blue gamma generation unit 22 for blue. The red gamma generation unit 20 generates red gamma voltages corresponding to red, the green gamma generation unit 21 generates green gamma voltages corresponding to green, and the blue gamma generation unit 22 generates blue gamma voltages corresponding to blue.

Each of the gamma generation units 20 to 22 may include a resistor string and amplifiers. Here, the resistor string divides a source voltage and generates voltages having various levels. The amplifiers amplify the voltages generated by the resistor string. The amplifiers are selectively turned on/off by enable signals GAM_REN, GAM_GEN and GAM_BEN.

The selection unit 24 selects any one from the outputs of the plurality of gamma generation units 20 to 22 and outputs the output to a common bus line CBL. The selection unit 24 may include a plurality of switches SW1, SW2 and SW3.

The first switch SW1 selectively transfers the output of the red gamma generation unit 20 to the common bus line CBL in response to a red selection signal MUX_RSEL. The second switch SW2 selectively transfers the output of the green gamma generation unit 21 to the common bus line CBL in response to a green selection signal MUX_GSEL. The third switch SW3 selectively transfers the output of the blue gamma generation unit 22 to the common bus line CBL in response to a blue selection signal MUX_BSEL.

The plurality of decoders 26 decodes the gamma voltages V<255:0> transferred to the common bus line CBL and outputs the decoded signals. The output unit 28 buffers the outputs of the decoders 26 and outputs source line driving signals S1 to 5256. The output unit 28 may include buffers for buffering the outputs of the decoders 26, resistors R respectively connected to the output terminals of the buffers 29, and capacitors C respectively connected to the resistors R.

In the display device according to embodiments having the above configuration, since the outputs of the gamma generation units 20 to 22 may be selectively transferred to the common bus line CBL using the selection signals MUX_RSEL, MUX_GSEL and MUX_BSEL of the respective colors, the number of common bus lines CBL may be reduced to about ⅓ of that of the related device.

The selection signals MUX_RSEL, MUX_GSEL and MUX_BSEL may be enabled at a logic low level at different timings as shown in example FIG. 3. The enable time points of the selection signals MUX_RSEL, MUX_GSEL and MUX_BSEL may be determined by a timing controller included in the display device.

For a display device having the structure of example FIG. 2, RC modeling of the gamma channel of each color is shown in example FIG. 4. Example FIG. 4 is a circuit diagram showing RC modeling of the display device according to embodiments.

Referring to example FIG. 4, a top gamma voltage Vgamma_top and a bottom gamma voltage Vgamma_bottom may be input to two resistors Rgamma. The two resistors Rgamma are commonly connected to a resistor Rmux corresponding to the first switch (e.g., SW1) of example FIG. 2.

In addition, a capacitor Cline denotes capacitance of a line to which a voltage V<255:0> of example FIG. 2 may be transferred, a resistor Rdec denotes resistor of the decoder 26, and a capacitor Csi corresponds to the capacitor C of example FIG. 2.

The RC modeling of example FIG. 4 may be expressed by Equation 1.

(Rgamma/2+Rmux)×2Cline+(Rgamma/2+Rmux+Rdec/1024)×1024×Csi (1)

The gamma channel of each color has an RC value of Equation 1 and the related display device has a total of three gamma channels. Thus, the RC value of the related display device is three times the RC value of Equation 1.

However, in the display device of embodiments, since the amplifiers which are not used in the gamma generation units 20 to 22 are turned off by the enable signals GAM_REN, GAM_GEN, and GAM_BEN, it is possible to reduce current consumption to about ⅓ of that of the related device. The enable signals GAM_REN, GAM_GEN, and GAM_BEN may be logically combined so as to selectively control ON/OFF of the amplifiers included in the gamma generation units 20 to 22.

Example FIG. 5 is a waveform diagram showing the waveforms of enable signals GAM_REN, GAM_GEN, and GAM_BEN of the display device according to embodiments. As shown in example FIG. 5, the amplifiers of the red gamma generation unit 20 are turned on when a logic combination is “1, 1, 0”, the amplifiers of the green gamma generation unit 21 are turned on when the logic combination is “0, 1, 1”, and the amplifiers of the blue gamma generation unit 22 are turned on when the logic combination is “1, 0, 1”.

In embodiments, since the gamma voltages corresponding to any one of the gamma voltages corresponding to the plurality of colors are selected and transferred to the common bus line, it is possible to reduce the number of bus lines. In addition, in embodiments, since at least one amplifier included in the plurality of gamma generation units 20 to 22 is turned off when the amplifiers for generating the gamma voltages are not used, it is possible to reduce current consumption.

It will be obvious and apparent to those skilled in the art that various modifications and variations can be made in the embodiments disclosed. Thus, it is intended that the disclosed embodiments cover the obvious and apparent modifications and variations, provided that they are within the scope of the appended claims and their equivalents.

What is claimed is:

1. An apparatus comprising:
a plurality of gamma generation units configured to generate gamma voltages corresponding to respective colors;
a selection unit configured to select gamma voltages corresponding to any one color from among the gamma voltages generated by the plurality of gamma generation units and to output the gamma voltages to a common line; and
a decoding unit configured to decode the gamma voltages output to the common line.

2. The apparatus of claim 1, wherein the plurality of gamma generation units includes:
a first gamma generation unit configured to generate first gamma voltages corresponding to red;
a second gamma generation unit configured to generate second gamma voltages corresponding to green; and
a third gamma generation unit configured to generate third gamma voltages corresponding to blue.

3. The apparatus of claim 2, wherein each of the first to third gamma generation units includes a resistor string.

4. The apparatus of claim 3, wherein each resistor string is configured to divide a source voltage so as to generate a plurality of voltage levels.

5. The apparatus of claim 2, wherein each of the first to third gamma generation units includes amplifiers.

6. The apparatus of claim 5, wherein the amplifiers respectively included in the first to third gamma generation units are configured to amplify the voltages generated by the resistor string.

7. The apparatus of claim 5, wherein the amplifiers respectively included in the first to third gamma generation units are configured to be turned on in response to enable signals.

8. The apparatus of claim 5, wherein the amplifiers respectively included in the first to third gamma generation units are turned on at different time points by the enable signals.

9. The apparatus of claim 2, wherein the selection unit includes a first switch configured to selectively transfer the first gamma voltages generated by the first gamma generation unit to the common line in response to a first selection signal.

10. The apparatus of claim 9, wherein the selection unit includes a second switch configured to selectively transfer the second gamma voltages generated by the second gamma generation unit to the common line in response to a second selection signal.

11. The apparatus of claim 10, wherein the selection unit includes a third switch configured to selectively transfer the third gamma voltages generated by the third gamma generation unit to the common line in response to a third selection signal.

12. The apparatus of claim 1, including an output unit.

13. The apparatus of claim 12, wherein the output unit is configured to output source line driving signals.

14. A method comprising:
generating gamma voltages corresponding to respective colors by a plurality of gamma generation units;
selecting gamma voltages corresponding to a specific color from among the gamma voltages by the plurality of gamma generation units and outputting the gamma voltages to a common line;
decoding the gamma voltages transferred to the common line.

15. The method of claim 14, wherein the gamma voltages corresponding to the respective colors include first gamma voltages corresponding to red, second gamma voltages corresponding to green and third gamma voltages corresponding to blue.

16. The method of claim 15, wherein the first to third gamma voltages are amplified and generated at different time points by enable signals.

17. The method according to claim 15, wherein the first gamma voltages are selectively transferred to the common line by a first selection signal, the second gamma voltages are selectively transferred to the common line by a second selection signal, and the third gamma voltages are selectively transferred to the common line by a third selection signal.

18. The method of claim 14, wherein the gamma voltages corresponding to the respective colors are generated by selectively amplifying the voltages generated by dividing a source voltage by enable signals.

19. The method of claim 14, including buffering the decoded signals.

20. The method of claim 14, including outputting the decoded signals for controlling source driver lines.
